(19) United States
(12) Patent Application Publication
(10) Pub. No.: US 2011/0035262 A1
(43) Pub. Date: Feb. 10, 2011

(54) Sponsoring and Distributing Content

(75) Inventors: Yoram Meriaz, Holon (IL); Ran Meriaz, Warner Robins, GA (US); Alex Tkachman, Holon (IL)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: MBTE Holdings Sweden AB

(21) Appl. No.: 12/559,780

(22) Filed: Sep. 15, 2009

Related U.S. Application Data
(60) Provisional application No. 61/232,469, filed on Aug. 10, 2009.

(51) Int. Cl. G06Q 30/00

(52) U.S. Cl. 705/14.1; 705/14.55

(57) ABSTRACT

Systems, methods, and computer program products are provided for distributing sponsored content. For example, in one embodiment, a facilitator system receives a distribution request to distribute sponsored content. In response to the distribution request, a distribution link for distributing the sponsored content is generated. The distribution link may be adapted for identifying a distributor account associated with the distribution link. In response to receiving a request for the sponsored content generated from the distribution link, the facilitator system can redirect a viewer computing device to the sponsored content stored on a host system and provide an incentive credit to the party who distributed the distribution link.

### CROSS-REFERENCE TO RELATED APPLICATIONS

This application claims priority to U.S. Provisional Application No. 61/232,469, filed Aug. 10, 2009, which is hereby incorporated herein in its entirety by reference.

### BACKGROUND

With the explosion of the Internet, content about products, companies, movies, food, services, locations, travel, etc. is readily accessible online with the aid of computing devices. The content regarding the above is often efficiently distributed among friends, groups, and networks using various mediums. For example, bloggers often post links to interesting articles on their blogs (or blog about the same), Facebook users may post a link to a particular movie review on their walls or distribute the same via Twitter, and the New York Times may publish reviews and articles on its website. In some instances, parties often create, distribute, and host content without any remuneration (monetary and otherwise) for doing so. In other instances, some of the parties who receive remuneration would like to be compensated further for their efforts. Thus, a need exists to further motivate, incentivize, and/or compensate parties for (a) creating content (e.g., blogging about products or services, writing an article, or making a video), (b) distributing content (e.g., communicating content to friends, groups, and networks), and (c) hosting the content on their systems (e.g., hosting content on one's blog or website).

### BRIEF SUMMARY

In general, embodiments of the present invention provide systems, methods, apparatus, and computer program products for sponsoring content to incentivize others to promote the content.

In accordance with one aspect, an advertising promotion computer system is provided. In one embodiment, the advertising promotion computer system comprises a facilitator system configured to receive a sponsorship request to sponsor a content item stored on a host computer system; receive a distribution request to distribute the sponsored content item, wherein the distribution request is associated with a distributor account; and generate a distribution link for distributing the sponsored content item, wherein the distribution link is adapted for (a) generating a sponsored content request and (b) identifying a distributor account associated with the distribution link. Additionally, the facilitator system is configured to receive a sponsored content request generated (a) from the distribution link (b) by a viewer computing device; identify the sponsored content item associated with the sponsored content request; and redirect the viewer computing device to the sponsored content item stored on the host computer system.

In accordance with another aspect, an advertising promotion computer system is provided. In one embodiment, the advertising promotion computer system comprises a facilitator system configured to cause display of information associated with a plurality of sponsored content items for distribution; receive a distribution request to distribute one of the plurality of sponsored content items, wherein the distribution request is associated with a distributor account; and generate a distribution link for distributing the sponsored content item, wherein the distribution link is adapted for (a) generating a sponsored content request and (b) identifying a distributor account associated with the distribution link. The facilitator system is also configured to receive a sponsored content request generated (a) from the distribution link (b) by a viewer computing device; identify the sponsored content item associated with the sponsored content request; and redirect the viewer computing device to the sponsored content item stored on a host computer system.

In accordance with yet another aspect, a computer program product is provided. The computer program product may comprise at least one computer-readable storage medium having computer-readable program code portions stored therein, the computer-readable program code portions comprising an executable portion configured to receive a sponsorship request to sponsor a content item stored on a host computer system; an executable portion configured to receive a distribution request to distribute the sponsored content item, wherein the distribution request is associated with a distributor account; and an executable portion configured to generate a distribution link for distributing the sponsored content item, wherein the distribution link is adapted for (a) generating a sponsored content request and (b) identifying a distributor account associated with the distribution link. The computer-readable code portions may also comprise an executable portion configured to receive a sponsored content request generated (a) from the distribution link (b) by a viewer computing device; an executable portion configured to identify the sponsored content item associated with the sponsored content request; and an executable portion configured to redirect the viewer computing device to the sponsored content item stored on the host computer system.

In accordance with still another aspect, a computer program product is provided. The computer program product may comprise at least one computer-readable storage medium having computer-readable program code portions stored therein, the computer-readable program code portions comprising an executable portion configured to cause display of information associated with a plurality of sponsored content items for distribution; an executable portion configured to receive a distribution request to distribute one of the plurality of sponsored content items, wherein the distribution request is associated with a distributor account; and an executable portion configured to generate a distribution link for distributing the sponsored content item, wherein the distribution link is adapted for (a) generating a sponsored content request and (b) identifying a distributor account associated with the distribution link. The computer-readable code portions may also comprise an executable portion configured to receive a sponsored content request generated (a) from the distribution link (b) by a viewer computing device; an executable portion configured to identify the sponsored content item associated with the sponsored content request; and an executable portion configured to redirect the viewer computing device to the sponsored content item stored on a host computer system.

And finally, in accordance with another aspect, a computer-implemented method is provided. The computer-implemented method may comprise receiving a distribution request to distribute a sponsored content item, wherein the distribution request is associated with a distributor account; generating a distribution link for distributing the sponsored content item, wherein the distribution link is adapted for (a) generating a sponsored content request and (b) identifying a distributor account associated with the distribution link; and receiving a sponsored content request generated (a) from the distribution link (b) by a viewer computing device. The computer implemented method may also comprise identifying the sponsored content item associated with the sponsored content request; and redirecting the viewer computing device to the sponsored content item stored on the host computer system.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an overview of one embodiment of a system that can be used to practice aspects of the present invention.

FIG. 2 shows an exemplary schematic diagram of a facilitator system according to one embodiment of the present invention.

FIGS. 3-5 show universal input and output produced by one embodiment of the invention.

FIG. 6 shows exemplary distribution links that can be used with various embodiments of the present invention.

FIG. 7 shows a flowchart illustrating operations and processes that can be used in accordance with various embodiments of the present invention.

FIG. 8 shows an exemplary link database entry that may be used to practice embodiments of present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout.

### I. Methods, Apparatus, Systems, and Computer Program Products

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Particular embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. General Overview

In general, according to various embodiments of the present invention, methods, apparatus, systems, and computer program products are provided for sponsoring content to incentivize others to promote the content. For example, a system may receive registration requests from a party/entity for creating content (e.g., writing an article), a party/entity for sponsoring content (e.g., providing an incentive to others for distributing the content), a party/entity for hosting the content (e.g., storing the content on a server for public or private access), and/or a party/entity for distributing the content (e.g., emailing links to the content to friends). Once content has been created, hosted, and sponsored, links to the content can be generated and distributed. In one embodiment, the links may be used to identify the content, distributor, sponsor, and others. Thus, upon the selection of one of the links, the accessing party is directed to a system that provides an incentive to the creator, host, and/or distributor in accordance with distribution parameters and redirects the accessing party to the content.

### III. Exemplary System Architecture

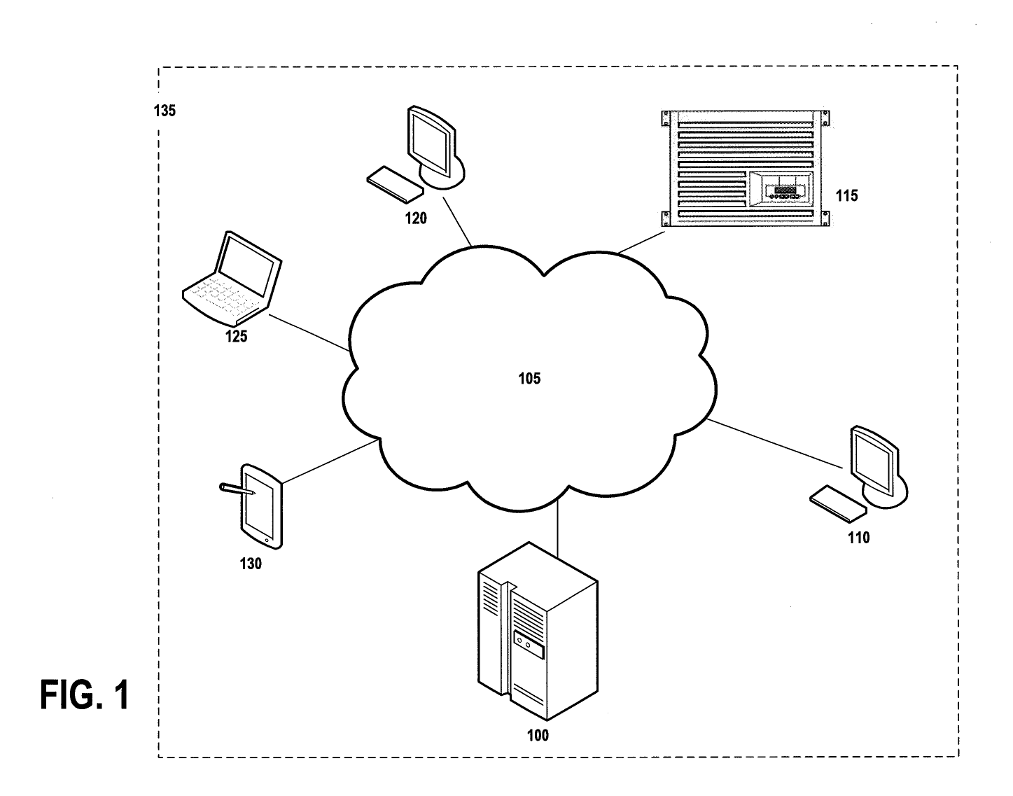

FIG. 1 provides an illustration of an advertising promotion computer system 135 that can be used in conjunction with various embodiments of the present invention. As shown in FIG. 1, the system may include a facilitator system 100, a network 105, a creator computing device 110, a host system 115, a sponsor computing device 120, a distributor computing device 125, and a viewer computing device 130. Each of these components of the system may be in electronic communication with, for example, one another over the same or different wireless or wired networks including, for example, a wired or wireless Personal Area Network (“PAN”), Local Area Network (“LAN”), Metropolitan Area Network (“MAN”), Wide Area Network (“WAN”), or the like. Additionally, while FIG. 1 illustrates the various system entities as separate, standalone entities, the various embodiments are not limited to this particular architecture.

a. Facilitator System

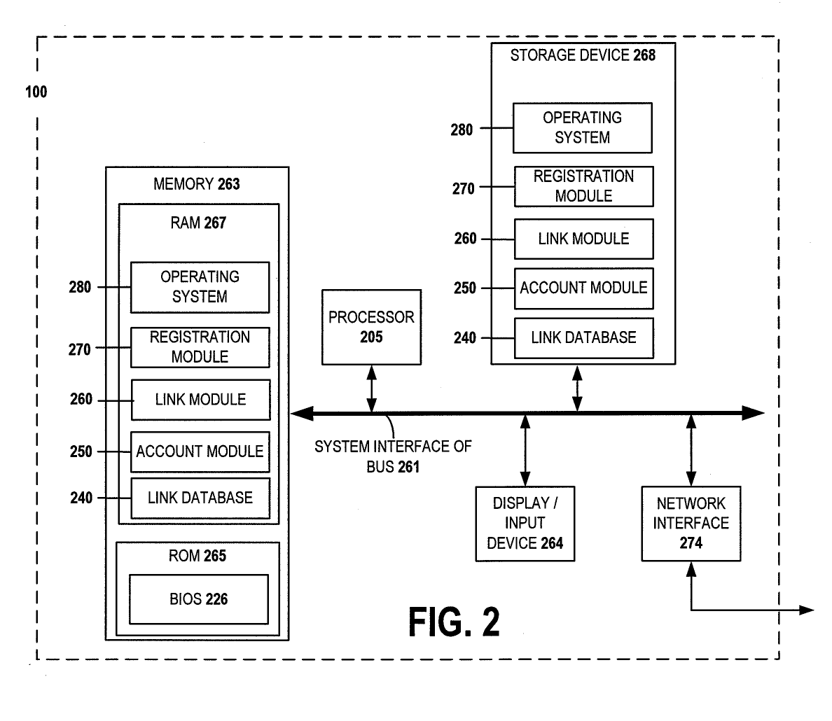

FIG. 2 provides a schematic of a facilitator system 100 according to one embodiment of the present invention. In general, the term “system” is used generically to refer to any computer, computing device, desktop, notebook or laptop, distributed system, server, gateway, switch, or other processing device adapted to perform the functions described herein. As will be understood from this figure, in this embodiment, the facilitator system 100 includes a processor 205 that communicates with other elements within the facilitator system 100 via a system interface or bus 261. The processor 205 may be embodied in a number of different ways. For example, the processor 205 may be embodied as various processing means such as a processing element, a coprocessor, a controller or various other processing devices including integrated circuits such as, for example, an application specific integrated circuit (“ASIC”), a field programmable gate array (“FPGA”), a hardware accelerator, or the like. In an exemplary embodiment, the processor 205 may be configured to execute instructions stored in the device memory or otherwise accessible to the processor 205. As such, whether configured by hardware or software methods, or by a combination thereof, the processor 205 may represent an entity capable of performing operations according to embodiments of the present invention while configured accordingly. A display device/input device 264 for receiving and displaying data is also included in the facilitator system 100. This display device/input device 264 may be, for example, a keyboard or pointing device that is used in combination with a monitor. The facilitator system 100 further includes memory 263, which may include both read only memory (“ROM”) 265 and random access memory (“RAM”) 267. The facilitator system's ROM 265 may be used to store a basic input/output system (“BIOS”) 226 containing the basic routines that help to transfer information to the different elements within the facilitator system 100.

In addition, in one embodiment, the facilitator system 100 includes at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or the like. Additionally, each of these storage devices 268 may be connected to the system bus 261 by an appropriate interface.

Furthermore, a number of program modules may be stored by the various storage devices 268 and/or within RAM 267. Such program modules may include an operating system 280, a registration module 270, a link module 260, and an account module 250. These modules may control certain aspects of the operation of the facilitator system 100 with the assistance of the processor 205 and operating system 280-although their functionality need not be modularized. In addition to the program modules, the facilitator system 100 may store or be connected to one or more databases, such as a link database 240, with one or more tables stored therein. The term “database” refers to a structured collection of records or data that is stored in a computer system, such as via a relational database, hierarchical database, or network database.

Also located within the facilitator system 100, in one embodiment, is a network interface 274 for interfacing with various computing entities. This communication may be via the same or different wired or wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the facilitator system 100 may be configured to communicate via wireless external communication networks using any of a variety of protocols, such as 802.11, general packet radio service (“GPRS”), wideband code division multiple access (“W-CDMA”), or any other wireless protocol.

It will be appreciated that one or more of the facilitator system's 100 components may be located remotely from other facilitator system 100 components. Furthermore, one or more of the components may be combined and additional components performing functions described herein may be included in the facilitator system 100.

b. Additional Exemplary System Components

The creator computing device 110, host system 115, sponsor computing device 120, distributor computing device 125, and viewer computing device 130 may each include components and functionality similar to that of the facilitator system 100. For example, in one embodiment, each of the entities may include: (1) a processor that communicates with other elements via a system interface or bus; (2) a display device/input device; (3) memory including both ROM and RAM; (4) a storage device; and (5) a network interface. These architectures are provided for exemplary purposes only and are not limiting to the various embodiments. The term “computing device” is used generically to refer to any computer, computing device, desktop, notebook or laptop, distributed system, server, gateway, switch, or other processing device adapted to perform the functions described herein.

### IV. Exemplary System Operation

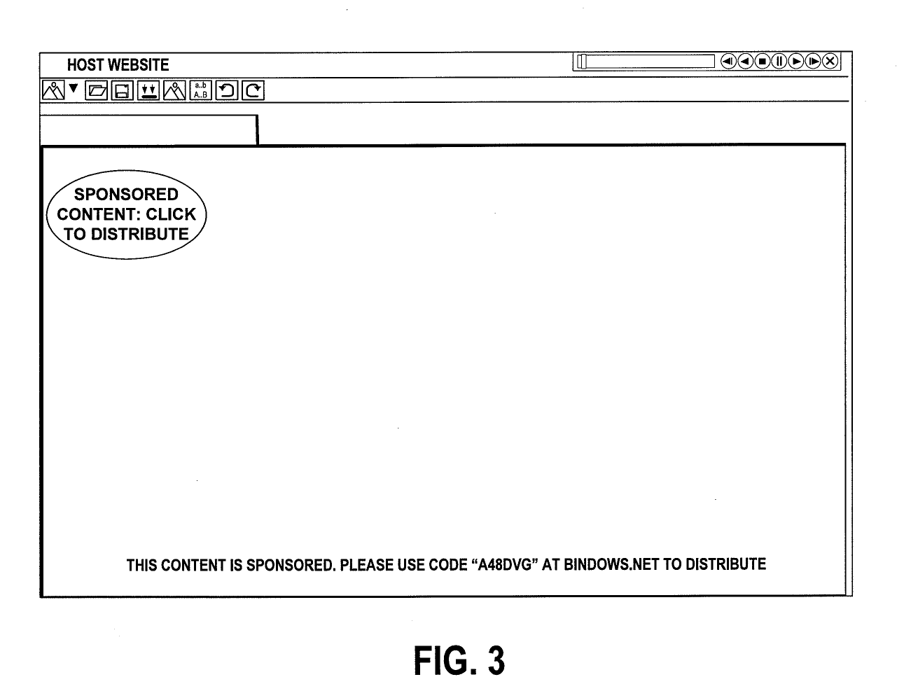

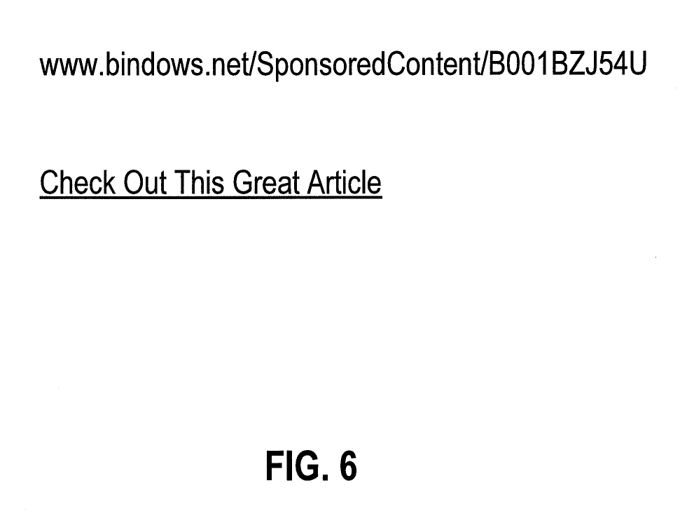

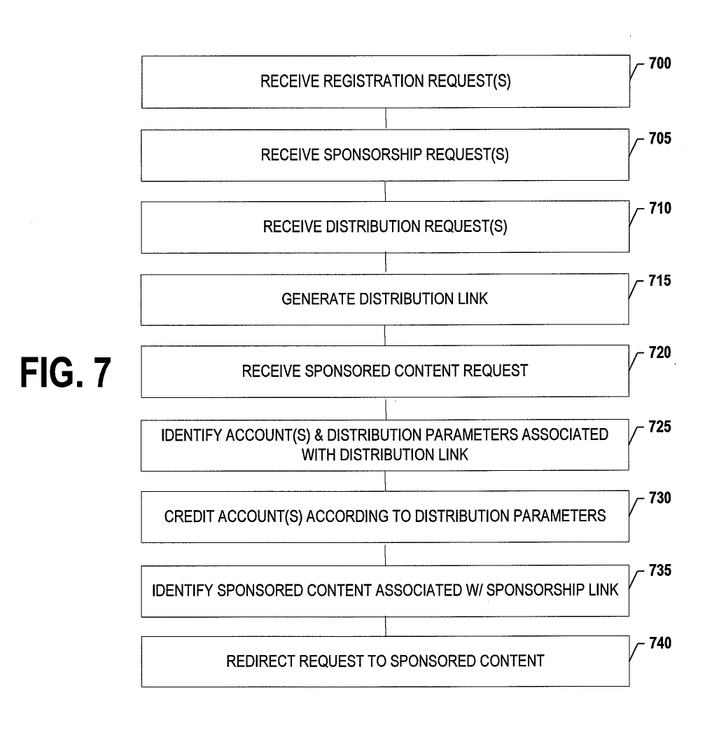

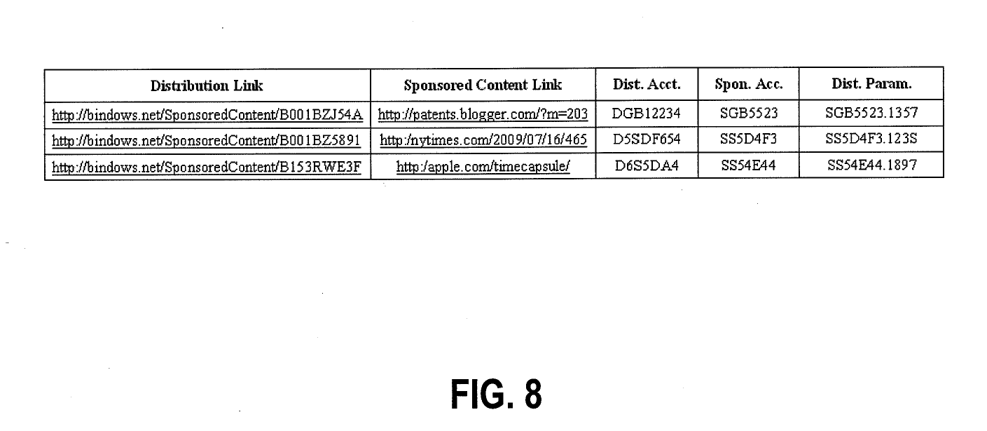

Reference will now be made to FIGS. 3-8. FIGS. 3-5 show universal input and output produced by one embodiment of the invention. FIG. 6 shows exemplary distribution links, and FIG. 7 provides a flowchart illustrating operations that may be performed to sponsor and distribute content. FIG. 8 shows an exemplary entry in the link database 240.

### a. Content

There is an abundance of content accessible via the Internet to satisfy a variety of needs. The term “content” may refer to any page, document, picture, music, review, video, book, information, and/or the like that is accessible via the Internet (e.g., also referred to as web content). Sometimes content is made available via other mediums in addition to the Internet, such as in printed newspapers and magazines, television broadcasts, billboards, movies, or a variety of other mediums (e.g., also referred to as non-web content). By way of example, web content and non-web content may include (a) a press release from a company regarding a new product it is introducing into the marketplace, (b) a music video posted on YouTube.com by an emerging band, (c) a restaurant review about a new downtown restaurant, or (d) an article about a manufacturer's environmentally unfriendly manufacturing process. Different entities may want the general public (or a targeted audience) to view such content for different reasons. For example, (a) the company may want certain users in Ohio to know of its new product, (b) the band may want people between the ages of 17-35 to view its video, (c) the restaurant owner may want business people in Atlanta to read the review, and (d) competitors of the manufacturer may want the general public to read about the manufacturer's environmentally unfriendly process. The following describes various embodiments for motivating, incentivizing, and/or compensating parties/entities for (a) creating content (e.g., blogging about products or services, writing an article, or making a video), (b) distributing content (e.g., communicating content or links to content to friends, groups, and networks), and (c) hosting content on their systems (e.g., hosting content on one's blog or website).

### b. Account Registration

In one embodiment, the process begins with the facilitator system 100 receiving one or more registration requests to participate in embodiments of the present invention by creating, hosting, sponsoring, and/or distributing content (Block 700 of FIG. 7). In other words, a creator (via a creator computing device 110), a host (via a host system 115), a sponsor (via a sponsor computing device 120), or a distributor (via a distributor computing device 125) can register via the facilitator system 100 to establish a creator account, a host account, a sponsor account, and/or a distributor account. Exemplary registration processes performed via a registration module 270, for example, are discussed in greater detail below.

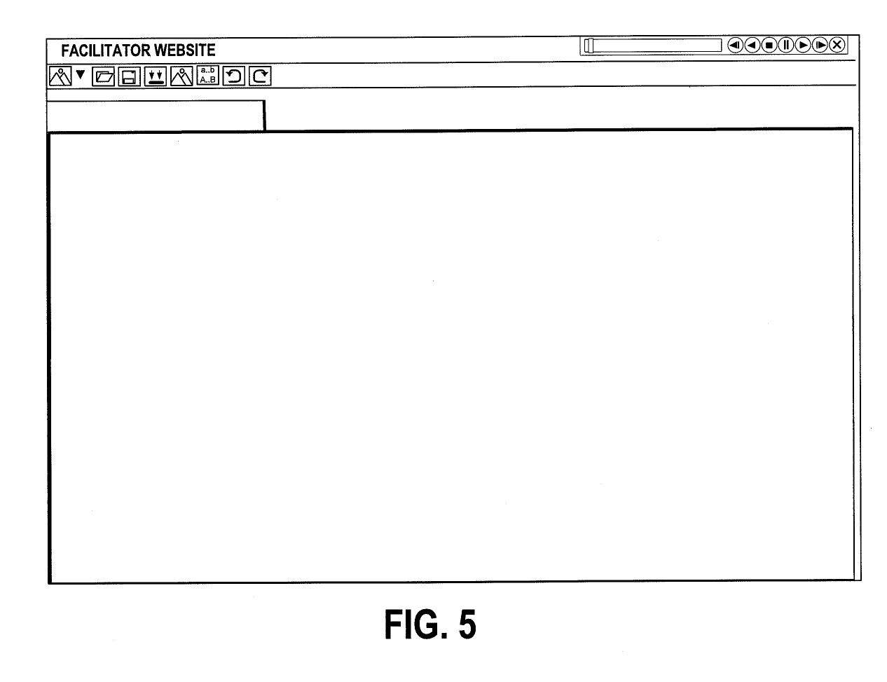

A creator (via a creator computing device 110) may initiate a creator registration request to the facilitator system 100. The creator registration request may be initiated by, for example, accessing a webpage provided by the facilitator system 115 (shown in FIG. 5). The term “creator” may refer to a party/entity who authors or owns content, such as an author of a blog, video, or article. Accordingly, the creator registration request is a request to establish a creator account, which provides the creator with the ability receive incentive credit(s) for creating content that is distributed. After receiving the creator registration request, the facilitator system 100 may create a creator account. The creator account may include information such as the creator's name, background, bank account or credit card information, terms and conditions for establishing a creator account, and/or the like.

Additionally, in one embodiment, a host (via the host system 115), such as the New York Times, may initiate a host registration request to the facilitator system 100. The host registration request may be initiated by, for example, accessing a webpage provided by the facilitator system 115 (shown in FIG. 5). As indicated above the term “host” may refer to any party/entity that hosts content for access (public or private) that can be viewed. Hosts may include, for example, the New York Times (e.g., the New York Times website), blogger.com, YouTube.com, or Bindows.net. Thus, the host registration request is a request to establish a host account, which provides the host the ability receive incentive credit(s) for hosting content on the host system 115 that is distributed and viewed. After receiving the host registration request, the facilitator system 100 may create a host account. The host account may include information about a particular company, such as a particular company's name, the company's website location, the number of years the company has been in operation, the company's bank account or credit card information, terms and conditions for establishing a host account, and/or the like.

Moreover, in one embodiment, a distributor (via a distributor computing device 125) may initiate a distributor registration request to the facilitator system 100. The distributor registration request may be initiated by, for example, accessing a webpage provided by the facilitator system 115 (shown in FIG. 5). The term “distributor” may refer to any party/entity who distributes content. For example, a distributor may distribute content (via a distributor computing device 125) by posting on a blog or tweeting a link to content. In other words, any party/entity with such capabilities can distribute content and therefore become a distributor. Accordingly, the distributor registration request is a request to establish a distributor account, which provides the distributor the ability receive incentive credit(s) for distributing content that may, for example, reside on a host system 115. After receiving the distributor registration request, the facilitator system 100 may create a distributor account for the distributor. The distributor account may include information such as the distributor's name, the distributor's bank account or credit card information, terms and conditions for establishing a distributor account, and/or the like.

As with the other parties/entities, in one embodiment, a sponsor (via a sponsor computing device 120) may initiate a sponsor registration request to the facilitator system 100. The sponsor registration request may be initiated by, for example, accessing a webpage provided by the facilitator system 115 (shown in FIG. 5). The term “sponsor” may refer to any party/entity who provides an incentive to others for creating, hosting, and/or distributing content. Continuing with the above example, a sponsor may be a company, restaurant, manufacturer, band, or public relations firm working on behalf of one of the foregoing. The sponsor registration request is a request to establish a sponsor account, which provides the sponsor with a means for providing incentive credit(s) to (a) creators for creating content, (b) hosts for hosting content, and/or (c) distributors for distributing content. After receiving the sponsor registration request, the facilitator system 100 may create a sponsor account for the sponsor. The sponsor account may include information such as the sponsor's name, the sponsor's website location, the number of years that the sponsor has been in operation, the sponsor's bank account or credit card information, terms and conditions for establishing a sponsor account, and/or the like.

The above parties/entities and accounts are illustrative and provided for understanding embodiments of the present invention. Thus, various embodiments may omit one or more of the above-discussed accounts (and/or parties/entities) and/or include additional accounts (and/or parties/entities) not discussed. Similarly, one or more of the parties/entities may have more than one account and/or more than one account type. For example, a party/entity may be both (a) a host and a distributor or (b) a creator and a host. Thus, the parties/entities and account types are not limiting to various embodiments of the present invention.

### c. Incentives and Incentive Credits

In one embodiment, with one or more of the above-discussed accounts created, a sponsor (via a sponsor account) can provide incentive credits for (a) creating content (e.g., blogging about products or services, writing an article, making a video, etc.), (b) distributing content (e.g., communicating content or links to content to friends, groups, and networks), and (c) hosting content on their systems (e.g., hosting content on one's blog or website). The terms “incentive” and “incentive credit” may refer to a stimulus received/receivable for creating, distributing, or hosting content. The incentive may be, for example, monetary credits (e.g., earning 15 cents for each identifiable party that views the content), ThankYou points, website credits (e.g., earning 10 cents in website credits for each identifiable party that views the content), reputation credits (e.g., earning 4 reputation credits for each identifiable party that views the content), and/or the like. The incentive credits may be accumulated over time and/or be made immediately available to the respective party.

In one embodiment, the creator, host, and/or distributor may all receive incentive credits. For instance, after a creator creates content, the creator (via a creator computing device 110) may upload or otherwise transmit content to a host system 115 for hosting (e.g., the New York Times website, blogger.com or blogspot.com, or a personal website). After receiving the content, the host system 115 may publish the content for public or private access. Accordingly, the content may then be viewed by one or more viewers (via one or more viewer computing devices 130). The term “viewer” may refer to a party/entity accessing content as a result of distribution. In that regard, the content or links to the content may be distributed (via one or more distributor computing devices 125) among, for example, friends, groups, or social/business networks for viewing. The distribution may include but is not limited to posting links to content on blogs, posting links to content on Facebook walls or distributing the same via Twitter, text messaging a link to a friend, emailing a link to a user group, or providing links to the content on various other electronic-based mediums and non-electronic-based mediums (e.g., flyers, books, and magazines). Often, the primary motivation to distribute such content is personal interest. However, with various embodiments of the present invention, the creator(s), host(s), and distributor(s) can all receive incentive credits for their respective roles.

### d. Content Sponsorships

In one embodiment, as indicated in Block 705 of FIG. 7, after content has been created and hosted (and in some embodiments even before), a sponsor (via a sponsor computing device 120) may initiate a sponsorship request to the facilitator system 100. The sponsorship request may be initiated in a variety of ways. In one embodiment, the facilitator system 100 may provide the sponsor with a webpage to access the sponsor account (e.g., via an account module 250). Once logged into the sponsor account, the sponsor (via the sponsor computing device 120) may initiate a sponsorship request to sponsor a particular blog entry that is accessible, for example, at http://patents.blogger.com/?m=203. As will be recognized, the sponsorship request may also be initiated in a variety of other ways.

In one embodiment, via the sponsorship request, the sponsor may identify (via the sponsor computing device 120) the content to be sponsored (e.g., a particular blog entry), its location (e.g., the blog entry that is accessible at http://patents.blogger.com/?m=203), and any distribution parameters associated with distributing the sponsored content. The distribution parameters may include a variety of different types of information. For example, the distribution parameters may identify the incentive credit receivable for distributing the sponsored content, such as monetary credits (e.g., earning 15 cents for each identifiable party that views the content), ThankYou points, website credits (e.g., earning 10 cents in website credits for each identifiable party that views the content), reputation credits (e.g., earning 4 reputation credits for each identifiable party that views the content), and/or the like.

The distribution parameters may also identify how the incentive credits will be applied to an account(s). For example, the distribution parameters may indicate that the incentive credits will be applied in increments of 50, e.g., requiring the accumulation of 50 incentive credits before they are applied to a distributor account. The distribution parameters may also identify the parties/entities eligible for receiving incentive credits, such as creators, hosts, and distributors.

In one embodiment, the distribution parameters may also establish a budget for the sponsored content. The budget may be used for applying incentive credits to creator accounts, host accounts, and distributor accounts. For example, the sponsor (via the sponsor computing device 120) may indicate that the first 1,000 times the sponsored content is accessed as the result of distribution, for each identifiable party that views the sponsored content, the responsible distributor will receive 8 cents in monetary credits and the host will receive 3 cents in monetary credits. After the first 1,000 times the sponsored content is accessed as the result of distribution, for each identifiable party that views the sponsored content as a result of distribution, the responsible distributor will receive 5 cents in monetary credits and the host will receive 2 cents in monetary credits. Similarly, the budget may limit the maximum amount to be used for sponsoring the content (e.g., the total number of incentive credits) to any amount, such as $300. Thus, in this example, after the budget of $300 is exhausted, no incentive credits will be applied to any accounts as a result of distribution. Additionally, budget funds or credits may be moved within a sponsor account or among sponsor accounts. For example, in one embodiment, budget funds may be reallocated from one item of sponsored content to another item of sponsored.

In one embodiment, the distribution parameters may also identify distribution medium requirements and/or requirements on the potential viewers of the sponsored content. For example, the distribution parameters may limit the distribution medium to particular distribution channels, such as Twitter, Facebook, YouTube, and/or email. Similarly, the distribution parameters may require the viewer (via a viewer computing device 130) to access the content (a) from a certain region (e.g., North America), (b) during a certain time (e.g., from 10:00 am-9:00 pm on Saturdays and Sundays), or (c) during a certain time period (e.g., within two weeks from the date the content was originally sponsored). Such distribution parameters may vary to help the sponsor target certain areas and demographics of viewers.

In one embodiment, the distribution parameters may also provide incentives to viewers for viewing the sponsored content as a result of distribution. For example, the distribution parameters may include an incentive for the first 100 viewers to access the sponsored content as a result of distribution. As one potential incentive, the first 100 viewers may be entered into a drawing or lottery to win a prize. As another potential incentive, the first 100 viewers may receive a digital coupon for a product or service. And as yet another potential incentive, the first 100 viewers may receive a free trial for a product or service. As will be recognized, a variety of incentive credits and distribution parameters can be used with embodiments of the present invention.

### e. Sponsored Content Identification

In one embodiment, after content has been sponsored, the sponsored content may be identified as such to alert distributors about the possibility of distributing the sponsored content. In various embodiments, this may be performed in a variety of ways. For example, in one embodiment, an icon, image, hyperlinked text, or any other link (referred to as a “sponsorship link”) may be caused to be displayed by the host system 115 (or other computing entities) in association with the sponsored content. As an example and as shown in FIG. 3, if the sponsored content is an article or a blog, a sponsorship link may be placed on the first webpage of the article or blog to indicate that the content is sponsored. The sponsorship link may be an icon or an image that reads “Sponsored Content: Click to Distribute.” In this example, the icon, image, hyperlinked text, or any other link may be selected to initiate a distribution request (Block 710 of FIG. 7). Similarly, the sponsorship link may be text that reads “This content is sponsored. Please use code “A48DVG” at www.bindows.net to distribute.” In this example, the code may be used as input to the facilitator system 100 to initiate a distribution request. It should be noted that in embodiments in which the creator is also a host, the creator (via the creator computing device 110) may identify the sponsored content as such using, for example, a sponsorship link.

In another embodiment, other mediums may be used to indicate that content is sponsored for distribution. For example, an article in a newspaper or magazine may indicate that the article is also available as web content and is sponsored for distribution. Further, an advertisement may be placed in a newspaper, magazine, or billboard to advertise that certain content is sponsored. And a television or radio advertisement may be broadcast to indicate that sponsored content is available for distribution. Thus, depending on the medium used, the sponsorship link may be a (a) barcode that can be scanned and decoded (e.g., a barcode displayed proximate an article in a magazine), (b) a QR code that can be scanned and decoded (e.g., a QR code displayed proximate a review in a newspaper), or (b) an alphanumeric code that can be entered as input (e.g., an advertisement on television, billboard, or in print that reads “This content is sponsored. Please use code ‘A48DVG’ at www.bindows.net to distribute.”). Such embodiments, will allow sponsors to reach out to potential distributors using both electronic and non-electronic mediums. Regardless of form, the various sponsorship links may be used to initiate a distribution request. Continuing with the above examples, (a) scanning a barcode, (b) scanning and decoding a QR code, or (b) inputting an alphanumeric code via a webpage provided by the facilitator system 100 can be used to initiate distribution requests.

In yet another embodiment, distributors or other parties/entities may log onto a webpage provided by the facilitator system 100 to access a registry of sponsored content that is sponsored for distribution. For example, upon logging into and navigating to an appropriate section, the facilitator system 100 may provide a registry of sponsored content that can be selected for distribution. Upon receiving a selection of a particular sponsored content to distribute, a distribution request to the facilitator system 100 may be initiated.

### f. Distribution Requests

In various embodiments of the present invention, the sponsorship link (in its various forms) may be used to initiate distribution requests. In an embodiment in which a sponsorship link is a code printed in a magazine, for example, the facilitator system 100 may require the distributor to login to a distributor account (or in some cases this may be the point at which a user registers to become a distributor) to enter the code contained in the sponsorship link. Thus, after logging in and entering the code via the appropriate field, the facilitator system 100 may generate and/or receive the distribution request. Accordingly, the facilitator system 100 may then generate a distribution link for the sponsored content.

Similarly, in an embodiment in which the sponsorship link is a barcode or QR code that can be scanned and decoded, scanning and decoding may initiate a distribution request. For example, decoding the barcode or QR code may provide a uniform resource locater (“URL”) that directs the distributor computing device 125 to a webpage on the facilitator system 100. The facilitator system 100 may require the distributor to login to a distributor account to continue with the distribution request. Accordingly, the facilitator system 100 may then generate a distribution link for the sponsored content.

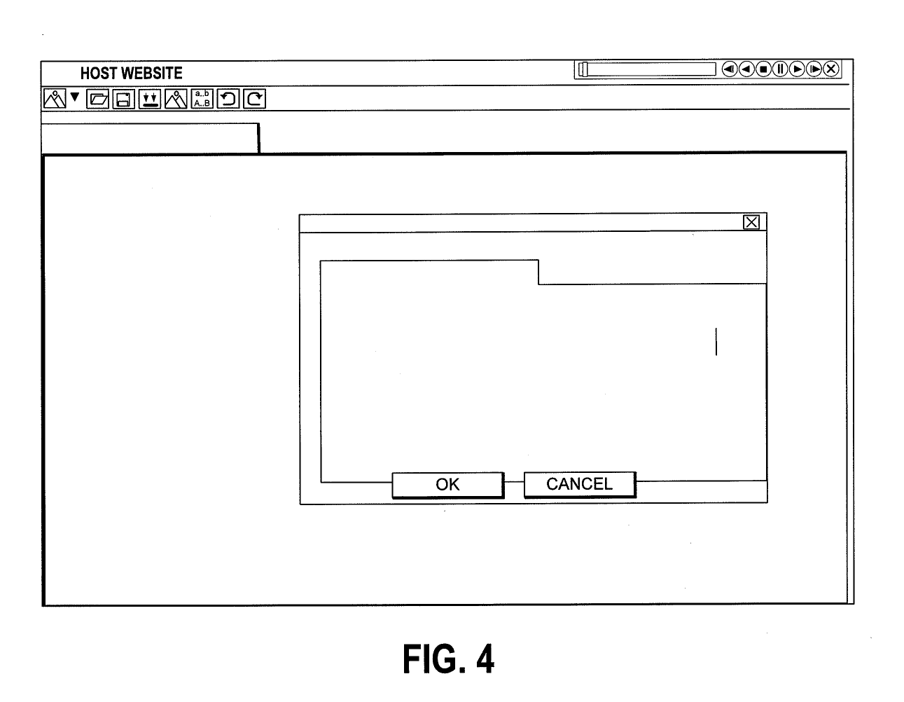

In an embodiment in which the sponsorship link is an icon, image, or hyperlinked text that is displayed in association with sponsored content, selection of the sponsorship link may initiate a distribution request. In this example, when a distributor (via the distributor computing device 125) selects the sponsorship link using a mouse, for example, the sponsorship link may cause the distributor computing device 125 to be directed to a webpage provided by the facilitator system 100 to login to a distributor account. As indicated previously, this may also be a point at which a user registers to become a distributor and creates a distributor account. Accordingly, the facilitator system 100 may then generate a distribution link for the sponsored content. Alternatively, in this example, instead of being directed to a webpage provided by the facilitator system 100, selecting the sponsorship link and initiating a distribution request may result in a dialogue box being displayed (via the distributor computing device 125). See, for example, FIG. 4. The dialogue box may provide the functionality of being in communication with, for example, the facilitator system 100. In such an embodiment, the dialogue box may allow the distributor computing device 125 to communicate with the facilitator system 100 to login to a distributor account and/or receive a distribution link generated in response to the distribution request.

In yet another embodiment, a host system 115 may receive a distribution request. For example, in an embodiment in which the sponsorship link is an icon, image, hyperlinked text displayed in association with the sponsored content, selection of the sponsorship link may initiate the distribution request that is received by the host system 115. In this example, the host system 115 may be in communication with the facilitator system 100 such that the host system 115 passes on the distribution request. Alternatively, the host system 115 may receive the distribution request and generate a distribution link in response. Thus, in this example, the host system 115 may be adapted to provide some of the functionality of the facilitator system 100 (e.g., generating distribution links) for additional convenience in attracting parties/entities to distribute sponsored content.

### g. Distribution Link Generation

In one embodiment, after receiving a distribution request, the facilitator system 100 may generate a distribution link (e.g., via a link module 260) for the sponsored content (Block 715 of FIG. 7). Note that in alternative embodiments, as discussed above, other computing entities, such as the host system 115 or creator computing device 110, may generate distribution links as well. The term “distribution link” may refer to a URL that can be used to, for example, identify (a) a particular sponsored content, (b) a distributor account associated with the distribution link (e.g., a distributor account that registered to distribute the sponsored content), and (c) a sponsor account associated with the distribution link (e.g., the sponsor account that sponsored the content).

In one embodiment, the distribution link directs the viewer (e.g., via a viewer computing device) to the facilitator system 100. For example, the distribution link may provide a location accessible via the Internet, such as the location accessible at www.bindows.net/SponsoredContent/B001BZJ54U. In another embodiment, the distribution link may be generated and masked as hyperlinked text, such as Check Out This Great Article (e.g., hyperlinked to www.bindows.net/SponsoredContent/B001BZJ54U). See, for example, FIG. 6. In one embodiment, a distribution link may be a shortened or tiny URL, such as those produced by www.bit.ly, www.tinylink.com, and www.shorturl.com.

In one embodiment, after generating the distribution link, the distribution link may be stored in the link database 240 in association with, for example, a URL to the sponsored content, a distributor account (e.g., a distributor account that registered to distribute the sponsored content), a sponsor account (e.g., the sponsor account that sponsored the content), and distribution parameters (e.g., parameters defined by the sponsor for distributing the content). Illustrative entries of the link database 240 are shown in FIG. 8. For example, the distribution link “www.bindows.net/SponsoredContent/B001BZJ54U” may be stored in association with (a) a URL to the sponsored content “http://patents.blogger.com/?m=203,” (b) a distributor account number “DGB12234,” (c) a sponsor account number “SGB5523,” and (d) distribution parameters associated with the sponsor account and the sponsored content “SGB5523.1237.” In this example, the alphanumeric code “SGB5523.1237” identifies the set of distribution parameters.

In one embodiment, a distribution link is generated for each distributor of sponsored content. In other words, the distribution link uniquely identifies the sponsored content and the distributor account. Thus, for example, if a second distributor (via a distributor computing device 125) initiates a distribution request to distribute content, the distribution link for the second distributor would uniquely identify the sponsored content and the second distributor. Once a distribution link has been generated, the distribution link can be distributed (e.g., transmitted) to one or more distribution computing devices 125.

### h. Distribution ofDistribution Links

In one embodiment, after receiving a distribution link, a distributor (e.g., via a distributor computing device 125) can distribute (e.g., transmit) the distribution link to potential viewers. For example, the distributor (e.g., via a distributor computing device 125) may post the distribution link on a blog with text that encourages potential viewers to select the distribution link. The distributor (e.g., via a distributor computing device 125) may post the distribution link on a Facebook wall or tweet the distribution link via Twitter. The distributor may also email or text message the distribution link to a friend, distribution list, or user group. It should be noted that distributing the distribution link is not limited to electronic mediums. For example, the distribution link may be distributed using non-electronic mediums as well, such as paper.

When a viewer decides to view the sponsored content, the viewer (e.g., via a viewer computing device 130) accesses the distribution link. For example, the viewer (e.g., via a viewer computing device 130) can select the distribution link (e.g., by double clicking) to initiate a sponsored content request. Similarly, the viewer (e.g., via a viewer computing device 130) may input the distribution link into the address field of a browser to initiate a sponsored content request. The sponsored content request directs the viewer (e.g., via a viewer computing device 130) to the location of the distribution link, such as the facilitator system 100. When the facilitator system 100 receives the sponsored content request (Block 720 of FIG. 7), the facilitator system 100 may identify the distributor account, sponsor account, and distribution parameters associated with the distribution link. For example, the facilitator system 100 may look up the distribution link associated with the sponsored content request in the link database 240 (Block 725 of FIG. 7). See, for example, FIG. 8.

In one embodiment, after identifying the distribution parameters, the facilitator system 100 determines if the sponsored content request is within the distribution parameters. This may include a variety of functions. For example, this may include determining if the sponsored content request (a) originates from a particular distribution channel (e.g., Twitter, Facebook, or YouTube), (b) originates from a certain region (e.g., North America), and/or (b) is within a certain time or time period (e.g., from 10:00 am-9:00 pm or within two weeks from the date the content was sponsored). Moreover, the facilitator system 100 may determine what accounts are to be credited (and the amounts) as a result of the sponsored content request, e.g., a creator account(s), a distributor account(s), and/or a host account(s). The facilitator system 100 may also determine if there are sufficient incentive credits in the sponsor's budget for the sponsored content to apply to the respective accounts in accordance with the distribution parameters.

In summary, the facilitator system 100 identifies the distribution parameters and determines if the sponsored content request is in compliance with the same. If the sponsored content request is in compliance with the distribution parameters, the facilitator system 100 credits the appropriate accounts with the appropriate incentive credits (Block 730 of FIG. 7) in accordance with the distribution parameters. For example, the distributor account may be credited with 8 cents in monetary credits and the host account may be credited with 3 cents in monetary credits. The facilitator system 100 may also adjust the sponsor account budget to reflect the application of the incentive credits to, for example, a creator's account, a host's account, and a distributor's account.

Additionally, in one embodiment, before redirecting the sponsor to the sponsored content, depending on the distribution parameters, the viewer (via a viewer computing device 130) may be provided with the option of being entered into a lottery or drawing. Similarly, the viewer (via a viewer computing device 130) may be provided with a digital coupon for a product or service or be offered a free trial for a product or service. In another embodiment, the facilitator system 100 may provide the viewer (via a viewer computing device 130) with an advertisement to view. For example, the advertisement may be a targeted advertised associated with the sponsored content or the demographics of the viewer. It should be noted that the discussed alternatives may be provided to the viewer before, after, or simultaneously with being directed to the sponsored content, e.g., via pop up windows and/or the like. See, for example, FIG. 4.

In one embodiment, after receiving a sponsored content request, the facilitator system 100 identifies a link to the sponsored content and redirects the viewer (via a viewer computing device 130) to the sponsored content (Block 735 of FIG. 7). For example, the facilitator system may redirect the viewer (via a viewer computing device 130) to the sponsored content accessible at http://patents.blogger.com/?m=203 (Block 740 of FIG. 7).

### i. Additional Embodiments

Embodiments of the present invention may also provide a variety of additional functions as well. For example, upon receiving a distribution link, a viewer may decide to become a distributor. Thus, after registering (or logging into an existing distributor account) the viewer may initiate a distribution request. This may be performed in a variety of ways, such as those discussed above. Alternatively though, the viewer (via a viewer computing device 130) may input the distributor's distribution link (e.g., www.bindows.net/SponsoredContent/B001BZJ54U) via a webpage provided by the facilitator system 100 to initiate a distribution request. In such a case, the viewer (via a viewer computing device 130) may become a sub-distributor (or co-distributor) of the distributor such that both parties receive incentive credits when viewer's distribution link is used to view the sponsored content (e.g., http://patents.blogger.com/?m=203). In this example, the viewer (e.g., via a viewer computing device 130) is registering the distributor's distribution link, not a link to the sponsored content. This will result in the generation of a distribution link for the viewer than can then be distributed such that both the viewer (e.g., sub- or co-distributor) and distributor receive incentive credit.

In one embodiment, various antifraud mechanisms may be used to enforce the distribution parameters. For example, the facilitator system 100 may require that a unique Internet Protocol (“IP”) address be associated with each sponsored content request to receive incentive credit. As will be recognized, various other antifraud mechanisms may also be implemented within the scope of the embodiments of the present invention.

In one embodiment, the facilitator system 100 may also provide creators, distributors, hosts, and sponsors with the ability to communicate with one another (e.g., via their respective computing devices). For example, the facilitator system 100 may provide the parties/entities with the ability to exchange notifications between them regarding existing and future content and particular incentives.

In yet another embodiment, the facilitator system 100 may provide a voting mechanism for viewers of the sponsored content. For example, a viewer (via a viewer computing device 130) may use a voting pop-up window to indicate the quality of the sponsored content, which may be used as feedback for the creator, host, sponsor, and/or distributor.

### V. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An advertising promotion computer system comprising:
a facilitator computer system, the facilitator computer system comprising one or more memory storage areas and one more processors, the facilitator computer system being configured to:
receive a sponsorship request to sponsor a content item stored on a host computer system;
receive a distribution request to distribute the sponsored content item, wherein the distribution request is associated with a distributor account;
generate a distribution link for distributing the sponsored content item, wherein the distribution link is adapted for (a) generating a sponsored content request and (b) identifying a distributor account associated with the distribution link;
receive a sponsored content request generated (a) from the distribution link (b) by a viewer computing device;
identify the sponsored content item associated with the sponsored content request; and
redirect the viewer computing device to the sponsored content item stored on the host computer system.

2. The advertising promotion computer system of claim 1, wherein the facilitator computer system is further configured to:
identify a distributor account associated with the distribution link based at least in part on the sponsored content request;
identify a sponsor account associated with the sponsored content item based at least in part on the sponsored content request; and
identify distribution parameters associated with distributing the sponsored content item.

3. The advertising promotion computer system of claim 2, wherein the facilitator computer system is further configured to:
apply an incentive credit to the distributor account in accordance with the distribution parameters; and
update the sponsor account to reflect the incentive credit applied to the distributor account in accordance with the distribution parameters.

4. The advertising promotion computer system of claim 1, wherein (a) the sponsorship request is associated with a sponsor account and (b) the sponsorship request identifies distribution parameters for distributing the sponsored content item

5. The advertising promotion computer system of claim 1, wherein the facilitator computer system is further configured to:
receive a sponsor registration request, wherein (a) the sponsor registration request is a request to establish a sponsor account, (b) the sponsor account provides the ability provide an incentive credit for distributing the sponsored content item;
create a sponsor account based on the sponsor registration request;
receive a distributor registration request, wherein (a) the distributor registration request is a request to establish a distributor account and (b) the distributor account provides the ability to receive an incentive credit for distributing the sponsored content item; and
create a distributor account based on the distributor registration request.

6. The advertising promotion system of claim 1, wherein the facilitator computer system is further configured to:
identify a host account associated with the distribution link based at least in part on the sponsored content request;
identify the distribution parameters associated with distributing the sponsored content item; and
apply an incentive credit to the host account in accordance with the distribution parameters.

7. The advertising promotion system of claim 6, wherein the facilitator computer system is further configured to:
receive a host registration request, wherein (a) the host registration request is a request to establish a host account, (b) the host account provides the ability receive an incentive credit for hosting the sponsored content item on the host computer system; and
create a host account based on the host registration request.

8. The advertising promotion system of claim 1, wherein the distribution parameters for distributing the sponsored content item include an incentive credit budget to be used in accordance with the distribution parameters.

9. The advertising promotion system of claim 1, wherein the distribution parameters for distributing the sponsored content item include requiring that the sponsored content request be (a) initiated from a certain region and (b) initiated during a specific time period.

10. The advertising promotion system of claim 1, wherein the incentive credit is selected from one of the group consisting of: (a) a monetary credit; (b) a reputation credit; and (c) a website credit.

11. The advertising promotion system of claim 1, further comprising a distributor computing device, the distributor computing device comprising one or more memory storage areas and one more processors, the distributor computing device being configured to:
receive the distribution link from the facilitator computer system; and
initiate transmission of the distribution link to a plurality of viewer computing devices.

12. The advertising promotion system of claim 1, wherein the host computer system comprises one or more memory storage areas and one more processors, and the host computer system is configured to:
cause display of a sponsorship link proximate the sponsored content item, wherein the sponsorship link (a) is adapted for generating distribution requests to the facilitator computer system and (b) identifies the sponsored content item to the facilitator computer system.

13. The advertising promotion system of claim 12, wherein the distribution request is generated by a distributor computing device in response to receiving an input selecting the sponsorship link.

14. The advertising promotion system of claim 1, wherein the distribution request is generated in response to receiving a distribution code entered in as input into a distributor computing device.

15. The advertising promotion system of claim 1, wherein the distribution request is generated in response to receiving a distribution code received by a distributor computing device from a scan of the distribution code.

16. The advertising promotion system of claim 1, wherein the viewer computing device comprises one or more memory storage areas and one more processors, the viewer computing device configured to:
generate and transmit the sponsored content request to the facilitator computer system; and
cause display of the sponsored content item in response to a redirection by the facilitator computer system.

17. An advertising promotion system comprising:
a facilitator computer system, the facilitator computer system comprising one or more memory storage areas and one more processors, the facilitator computer system being configured to:
cause display of information associated with a plurality of sponsored content items for distribution;
receive a distribution request to distribute one of the plurality of sponsored content items, wherein the distribution request is associated with a distributor account;
generate a distribution link for distributing the sponsored content item, wherein the distribution link is adapted for (a) generating a sponsored content request and (b) identifying a distributor account associated with the distribution link;
receive a sponsored content request generated (a) from the distribution link (b) by a viewer computing device;
identify the sponsored content item associated with the sponsored content request; and
redirect the viewer computing device to the sponsored content item stored on a host computer system.

18. The advertising promotion system of claim 17, wherein the facilitator computer system is further configured to:
identify a distributor account associated with the distribution link based at least in part on the sponsored content request;
identify a sponsor account associated with the sponsored content item based at least in part on the sponsored content request; and
identify distribution parameters associated with distributing the sponsored content item.

19. The advertising promotion system of claim 18, wherein the facilitator computer system is further configured to:
apply an incentive credit to the distributor account in accordance with the distribution parameters; and
update the sponsor account to reflect the incentive credit applied to the distributor account in accordance with the distribution parameters.

20. The advertising promotion system of claim 17, wherein the facilitator computer system is further configured to:
identify a host account associated with the distribution link based at least in part on the sponsored content request;
identify the distribution parameters associated with distributing the sponsored content item; and
apply an incentive credit to the host account in accordance with the distribution parameters.

21. A computer program product comprising at least one computer-readable storage medium having computer-readable program code portions stored therein, the computer-readable program code portions comprising:
an executable portion configured to receive a sponsorship request to sponsor a content item stored on a host computer system;
an executable portion configured to receive a distribution request to distribute the sponsored content item, wherein the distribution request is associated with a distributor account;
an executable portion configured to generate a distribution link for distributing the sponsored content item, wherein the distribution link is adapted for (a) generating a sponsored content request and (b) identifying a distributor account associated with the distribution link;
an executable portion configured to receive a sponsored content request generated (a) from the distribution link (b) by a viewer computing device;
an executable portion configured to identify the sponsored content item associated with the sponsored content request; and
an executable portion configured to redirect the viewer computing device to the sponsored content item stored on the host computer system.

22. The computer program product of claim 21, further comprising:
an executable portion configured to identify a distributor account associated with the distribution link based at least in part on the sponsored content request;
an executable portion configured to identify a sponsor account associated with the sponsored content item based at least in part on the sponsored content request; and
an executable portion configured to identify distribution parameters associated with distributing the sponsored content item.

23. The computer program product of claim 22, further comprising:
an executable portion configured to apply an incentive credit to the distributor account in accordance with the distribution parameters; and
an executable portion configured to update the sponsor account to reflect the incentive credit applied to the distributor account in accordance with the distribution parameters.

24. The computer program product of claim 21, further comprising:
an executable portion configured to receive a sponsor registration request, wherein (a) the sponsor registration request is a request to establish a sponsor account, (b) the sponsor account provides the ability provide an incentive credit for distributing the sponsored content item;
an executable portion configured to create a sponsor account based on the sponsor registration request;
an executable portion configured to receive a distributor registration request, wherein (a) the distributor registration request is a request to establish a distributor account and (b) the distributor account provides the ability to receive an incentive credit for distributing the sponsored content item; and
an executable portion configured to create a distributor account based on the distributor registration request.

25. The computer program product of claim 21, further comprising:
an executable portion configured to identify a host account associated with the distribution link based at least in part on the sponsored content request;
an executable portion configured to identify the distribution parameters associated with distributing the sponsored content item; and
an executable portion configured to apply an incentive credit to the host account in accordance with the distribution parameters.

26. A computer program product comprising at least one computer-readable storage medium having computer-readable program code portions stored therein, the computer-readable program code portions comprising:
an executable portion configured to cause display of information associated with a plurality of sponsored content items for distribution;
an executable portion configured to receive a distribution request to distribute one of the plurality of sponsored content items, wherein the distribution request is associated with a distributor account;
an executable portion configured to generate a distribution link for distributing the sponsored content item, wherein the distribution link is adapted for (a) generating a sponsored content request and (b) identifying a distributor account associated with the distribution link;
an executable portion configured to receive a sponsored content request generated (a) from the distribution link (b) by a viewer computing device;
an executable portion configured to identify the sponsored content item associated with the sponsored content request; and
an executable portion configured to redirect the viewer computing device to the sponsored content item stored on a host computer system.

27. The computer program product of claim 26, further comprising:
an executable portion configured to identify a distributor account associated with the distribution link based at least in part on the sponsored content request;
an executable portion configured to identify a sponsor account associated with the sponsored content item based at least in part on the sponsored content request; and
an executable portion configured to identify distribution parameters associated with distributing the sponsored content item.

28. The computer program product of claim 27, further comprising:
an executable portion configured to apply an incentive credit to the distributor account in accordance with the distribution parameters; and
an executable portion configured to update the sponsor account to reflect the incentive credit applied to the distributor account in accordance with the distribution parameters.

29. The computer program product of claim 26, further comprising:
an executable portion configured to identify a host account associated with the distribution link based at least in part on the sponsored content request;
an executable portion configured to identify the distribution parameters associated with distributing the sponsored content item; and
an executable portion configured to apply an incentive credit to the host account in accordance with the distribution parameters.

30. A computer implemented method comprising:
receiving, via one or more processors, a distribution request to distribute a sponsored content item, wherein the distribution request is associated with a distributor account;
generating, via one or more processors, a distribution link for distributing the sponsored content item, wherein the distribution link is adapted for (a) generating a sponsored content request and (b) identifying a distributor account associated with the distribution link;
receiving, via one or more processors, a sponsored content request generated (a) from the distribution link (b) by a viewer computing device;
identifying, via one or more processors, the sponsored content item associated with the sponsored content request; and
redirecting, via one or more processors, the viewer computing device to the sponsored content item stored on the host computer system.

31. The computer-implemented method of claim 30, further comprising:
identifying, via one or more processors, a distributor account associated with the distribution link based at least in part on the sponsored content request;
identifying, via one or more processors, a sponsor account associated with the sponsored content item based at least in part on the sponsored content request; and
identifying, via one or more processors, distribution parameters associated with distributing the sponsored content item.

32. The computer-implemented method of claim 30, further comprising:
applying, via one or more processors, an incentive credit to the distributor account in accordance with the distribution parameters; and
updating the sponsor account to reflect the incentive credit applied to the distributor account in accordance with the distribution parameters.
